(19) United States
(12) Patent Application Publication
(10) Pub. No.: US 2011/0001782 A1
(43) Pub. Date: Jan. 6, 2011

(54) METHOD AND APPARATUS FOR IMPROVING FLEXIBILITY OF INK PRINTED ONTO SUBSTRATES USING IRRADIATION CURE CONTROL

(75) Inventors: James M. Jang, South Windsor, CT (US); John E. Lafleche, Tolland, CT (US); Charles H. Dooley, Stafford, CT (US); Russel F. Croft, Tolland, CT (US)

Correspondence Address: CROWELL & MORING LLP;INTELLECTUAL PROPERTY GROUP, P.O. BOX 14300, WASHINGTON, DC, 20044-4300, US

(73) Assignee: GERBER SCIENTIFIC INTERNATIONAL, INC, South Windsor, CT (US)

(21) Appl. No.: 12/680,481

(22) PCT Filed: Sep. 26, 2008
(86) PCT No.: PCT/US08/77860

§ 371 Date: Sep. 22, 2010

Related U.S. Application Data
(60) Provisional application No. 60/975,815, filed on Sep. 27, 2007.
(60) Provisional application No. 60/975,908, filed on Sep. 28, 2007.

(51) Int. Cl. B41J 2/01

(52) U.S. Cl. 347/102

(57) ABSTRACT

This invention discloses a method and apparatus for improving the flexibility of ink and substrate. In particular, systems utilizing cationic inks such as Ultra Violet cured ink can control the flexibility of the ink and substrate layer the ink is applied on by using Ultra Violet irradiation control.

### FIELD OF THE INVENTION

This invention relates to controlling the flexibility of ink and substrate, and more particularly relates to Ultra Violet cured ink and controlling the flexibility of the ink and substrate layer the ink is applied on using Ultra Violet irradiation control.

### BACKGROUND OF THE INVENTION

Historically, ink jet units or similar such printing units that dispense ink on a substrate can use a variety of inks. Ink types include, for example, aqueous ink, oil ink, solvent ink, and Ultra Violet ink (UV cure ink) (hereafter, referred to as UV ink).

UV ink gets cured by photo-curing reaction with a UV ray. Curing of the UV ink occurs by a reaction between a photopolymerization initiator contained in the UV ink and a monomer or oligomer that is induced by a UV ray to form a highly polymerized compound, resulting in the cured UV ink. In addition to this property, the UV ink has such another property that it tends to get cured in a short period of time, for example within one second after being discharged, preventing an organic solvent contained it from evaporating. Further, the UV ink is excellent in abrasion resistance than other types of ink. Owing to these advantages, a demand for UV ink and UV ink jet units are increasingly growing.

Existing apparatus that dispense UV ink typically have the ability to print onto flexible and rigid substrates and cure inks using a UV source. Typical UV sources in commercial UV printers use medium pressure mercury Arc or vapor lamps. This type of arc lamp is used, for example, in Gerber Scientific Products Inc.'s (GSP's) current product, Solara UV2.

One issue with existing UV inks, which are typically made from free radical type of chemistry, are that the ink tends to be relatively brittle when printed and cured onto the surface of flexible materials. One such flexible material used in many applications is vinyl. For many applications, vinyl with a printed image on the vinyl must remain somewhat conformable, because end users desire to take printed vinyl images and stretch them onto surfaces. These types of applications, including ‘vehicle wrap applications’, requires the ink to remain flexible when printed and cured on the substrate surface. Typical free radical UV inks are not flexible enough for this application. Some UV inks can be specially formulated to be flexible; however, they lose properties like hardness and scratch resistance which are desirable when printing onto more rigid substrates. Several multiple ink sets are commercially available for a single UV printer to serve both applications. However, this requires a costly ink changeover between ink types when different applications are desired.

Other issues for cationic types of UV inks are increased brittleness over time after the image has been printed. Typically, the ink becomes brittle over days or weeks. For example, cationic ink has been found to be 40-50% extendable without cracking when tested directly after printing and curing. However, this flexibility can be lost over time, for example after 1 day, which can be due to a dark cure process that is typical of cationic chemistry inks. For example, an extension of cured ink film may decrease and the vinyl substrate to which the ink is applied can become brittle due to the ink and less flexible or about 30% extendable after 1 day.

Thus, there remains a need in the art to overcome the issue of reduced flexibility of inks and substrates due to curing of the ink. There is also a need for a way to increase flexibility of the inks and substrates in view of the ink cure process.

### BRIEF SUMMARY OF THE INVENTION

This invention includes a new UV printing system that uses a unique arrangement of low pressure fluorescent UV lamps and a unique coupling of low pressure mercury vapor lamps with a cationic UV ink. The invention described herein may be use with any cationic ink/low pressure mercury vapor fluorescent light combination.

The invention includes not only the process, methods and articles of production, but also the apparatus, computer technology, control systems and quality control systems for utilizing the invention. The apparatus for using this invention is widely varied in nature, type and design and is able to print on a broad variety of materials, apply inks and chemicals, as well as to cure the printed products and articles of manufacture.

These, and other aspects of the present invention, are described in the following brief and detailed description of the drawings.

### BRIEF DESCRIPTION OF THE DRAWINGS

FIG. 1 is a diagram illustrating a normal printing and cure mode that may or may not utilize the principles of the invention.

FIG. 2 is a diagram illustrating a leading lamp cure mode utilizing the principles of the invention.

FIG. 3 is a diagram illustrating a trailing cure mode utilizing the principles of the invention.

### DETAILED DESCRIPTION OF THE INVENTION

To overcome the issue of reduced flexibility on substrates, including but not limited to vinyl, the invention provides a way to increase flexibility with UV irradiation control during the cationic ink cure process. Curing cationic ink with low UV light intensity and low UV dosage creates more flexibility of the ink and vinyl layer when printed onto a vinyl substrate as compared with a normal curing process that does not use the principles of the invention. Control of intensity is monitored since too low of intensity would cause loss of image resolution because ink droplets would begin the bleed and/or dewet. Therefore, an optimum level of intensity is needed to achieve both high flexibility and high resolution.

Very flexible curing on vinyl substrates (more than 200% elongation before ink cracking or vinyl breaking) is achieved when the printing ink is cured within a short time interval (minutes) between printing and curing (irradiation). This method has shown some real application issues like low resolution caused by ink bleeding on surface and reduced resolution of printing area.

Using the method provided herein, the printed ink was allowed to cure without losing original resolution and performance, and with increased flexibility. This method utilized curing with only one lamp system instead of two lamps from current Solara Ion printer. The flexibility of cured vinyl substrates (breaking of film) with this new method increased flexibility up to 80˜85% extension compared with less than 50% extension currently. Also flexibility of cured ink on vinyl (cracking of ink layer) is increased to over 60˜70% extension over time, to compare ˜40% extension achieved with current cure process (2 lamps). This new method provides enough flexibility of ink and vinyl substrates for some special applications. Such an effect could slightly vary with different vinyl substrates.

This new method has following advantages against current UV printing systems:
Easy control of lamp system with new GSP Solara Ion printer. Can turn one lamp on and one lamp off for easy UV intensity control. In other embodiments, we could also use less intense UV lamps or method of producing less intensity to get desired effect. (i.e. a dimmer control on the lamps, take away a lamp reflector)
Can use current cationic formulated UV ink without any modification.
Easy adjustability on printer and no need of extra addition or special hardware.
Possible feasibility for control of printed cure surface from matte to gloss using lower intensity.
Can use a single ink set to get a range of ink properties that are controlled by cure process rather than the formulation of the ink. End user does not have to switch between inks.
Increasing the flexibility of printed inks on vinyl substrates.

A variety of curing processes can be achieved with the invention including, but not limited to light cure, dark cure, dual cure, differential cure and cure techniques involving combinations of, but not limited to, the curing methods disclosed herein. This invention provides advantages which can include, but are not limited, to one or more of print rates in a range of from very slow, e.g., almost zero ft²/hr (“foot²/hour”) through about 6400 ft²/hr, or higher. The invention can employ cationic ink compositions and low intensity light to achieve low energy cure, energy efficient cure. The invention is low in heat generation and can be utilized with heat sensitive substrates, including but not limited to those with thermal expansions that lead out of plane deformation during curing, color changes or undesired temperature dependant changes. The apparatus employed can use light sources which can have a long light life, e.g., greater than 500 hours.

This invention can use light to cure cationic inks. “Light” includes all varieties of electromagnetic energy which can interact with the inks, ink systems and their components and constituents. The definition of “light” encompasses “Actinic light” which is light which produces an identifiable or measurable change when it interacts with matter. “Light” or “radiation” includes photochemically active radiation of the forms like particle beams accelerated particles, i.e., Electron beams, and electromagnetic radiation, i.e., UV radiation, visible light, UV light, X-rays, gamma rays.

Light Intensity” is a measurable characteristic relating to the energy emitted by an light source reported in units of Watts (W) or miliWatts (mW). In one embodiment a light has a wavelength in a range of about 100 nm to about 1200 nm and intensity in a range of about 0.0003 w/cm²/nm to 0.05 w/cm²/nm. When mentioned in this application, intensity refers to the intensity at the surface of a substrate and methods of measuring such intensity are well known to those skilled in the art.

A wide range of light and light sources can be utilized. Light having a wavelength in a range of about 100 nm to about 1200 nm and an intensity in a range of about 0.0003 W/cm²/nm to 0.05 W/cm²/nm can be used.

The invention can utilize light having a value from a broad range of light wavelengths, as well as from a broad range of light intensities. As stated above one embodiment utilizes light having a light wavelength in a range of about 100 nm to about 1200 nm and a light intensity of about 0.0003 W/cm²/nm to about 0.05 W/cm²/nm. Another embodiment utilizes light having a light wavelength in a range of about 100 nm to about 1200 nm and a light intensity of about 0.0003 W/cm²/nm to about 0.02 W/cm²/nm. Yet another embodiment utilizes light having a light wavelength in a range of about 100 nm to about 1200 nm and a light intensity of about 0.0003 W/cm²/nm to about 0.01 W/cm²/nm. A still further embodiment utilizes light having a light wavelength in a range of about 100 nm to about 1200 nm and a light intensity of about 0.0003 W/cm²/nm to about 0.008 W/cm²/nm.

Light sources which can be used in this invention include, but are not limited to: a light bulb, fluorescent light source, LED, natural light, amplified light, electromagnetic radiation, a lamp, a gas lamp. A nonlimiting example of a gas lamp includes, a UV Systems TripleBright II lamp which is a type of gas discharge lamp utilizing a pair of electrodes, one at each end, and is sealed along with a drop of mercury and lamps having inert gases inside a glass tube. Light can originate from one source and/or location, a number of light sources and/or locations, or from an array of light sources. One or more types of lights, light sources, locations, configurations, orientations, intensities and wavelengths can be used in combination contemporaneously, sequentially, mixed, or timed without limitation.

The spectral output of a light source can be a function of one or more of the following nonlimiting factors: an atomic structure of one or more gas molecules, a temperature of a gas or gases, the pressure of a gas vapor in a light source. In some embodiments the output of phosphors (if optionally used) which are placed on the inside of the glass tube can affect the output of a light source.

In a nonlimiting example, a 254 nm bulb can have a peak at 253.7 nm. In this example the 254 nm bulb does not utilize phosphors and the output is primarily due to the absorption lines of mercury atoms. This can generate several emission lines of an extremely narrow bandwidth and a wavelength range of approximately 10 nm about the dominant lamp peak. Such wavelength ranges about peaks produced by light source are a result of the physics of light sources. Thus all values of wavelength should be construed to encompass ranges above and below the stated value for a respective light source.

As used herein, a substrate is any material onto which an amount of ink, or other material involved can be applied. Substrates include, but are not limited, to polyvinyl chloride (PVC), vinyl, and commercial cast and calendared vinyls, rigid and flexible substrates for nonlimiting examples such as those used in the signage and specialty graphics industry. Other substrates include, but are not limited to, metal, wood, plastic, fabrics, cotton, wool, others, and previously coated articles like automobiles.

A “substrate synthetic process” includes the compounding, forming, molding, pressing, extruding, pretreating and/or post treating and/or annealing to generate the final substrate for an application.

“Light cure” as used herein is broadly construed to include any chemical reaction, drying, hardening, physical change or transformation of an ink composition which results from or occurs during exposure to light. In one embodiment, “light cure” encompasses areas exposed to light with a 0.008 Watt/cm²/nm peak intensity at a wavelength of 254 nm.

Cure can be a function of light intensity and dosage as well as photoinitiator and sensitizer blend and level, acid nature of the substrate as well as the temperature of the ink, temperature of the substrate, the percent relative humidity and application environment temperature.

Variations in light exposure can occur as a result of multi-dimensionality of the substrate and various orientation to the photon direction, reflectance and absorption of photons due to polymers, photoinitators, pigments and other inks which can diminished photon penetration due to ink thickness and variation.

“Dark cure” as used herein is broadly construed to encompass any chemical reaction, drying, hardening, physical change or transformation of an ink composition which results in the absence of exposure to light at its coincident value on a surface directly exposed to a light source. A “dark area” is a portion of a substrate which is exposed to light at levels not equal to areas perpendicular to the direction of a light. Dark areas are herein broadly construed to encompass any area other than those directly exposed to light. Dark areas including portions of the ink composition which are exposed to no light, free of light, as well as areas which are exposed to less than the direct exposure of a light source. Further, dark areas can include those which are shaded, blocked, shadowed, covered, protected, or which for any reason do not receive direct exposure to a light source.

When an ink is applied to a substrate it has a thickness. In some embodiments, light exposure is not able to penetrate the thickness of an ink. In such instances, “dark area” is broadly construed to include the portions of the ink composition to which the light does not penetrate (or not penetrate with the fall intensity as from the source). As an ink layer becomes thicker, the ink becomes less flexible. The examples and testing done herein, include but are not limited to, testing done with a relatively thick layer of ink at about 42 pl ink drops on a 360×360 drop per inch grid onto the media. At least two ink drops are applied over each square in a 360 dpi square grid. It was found that this amount of ink per unit area is equivalent to the darkest portions of printed images. As an exemplary condition to test flexibility, all the samples tested herein were printed with this amount of ink. This amount of ink is referred to as 200% ink load in the below graphs.

An embodiment of this invention includes the curing of an ink or a portion of the ink by both light cure and dark cure. This combination of curing can occur where an amount of the ink composition cures as a result of light exposure and another amount of the ink of the same portion cures by chemical reaction or hardening process which is independent of exposure to light. Examples with dark cure can include, but are not limited, to drying, polymerization and/or reaction.

“Dual cure” is broadly construed herein to include any curing process in which an amount of ink composition is cured by, light cure and another amount is cured by any other method. Cures which are not considered to be light cure include chemical reaction independent of light including but not limited to drying and/or hardening, as well as including chemical reaction (e.g., polymerization reaction).

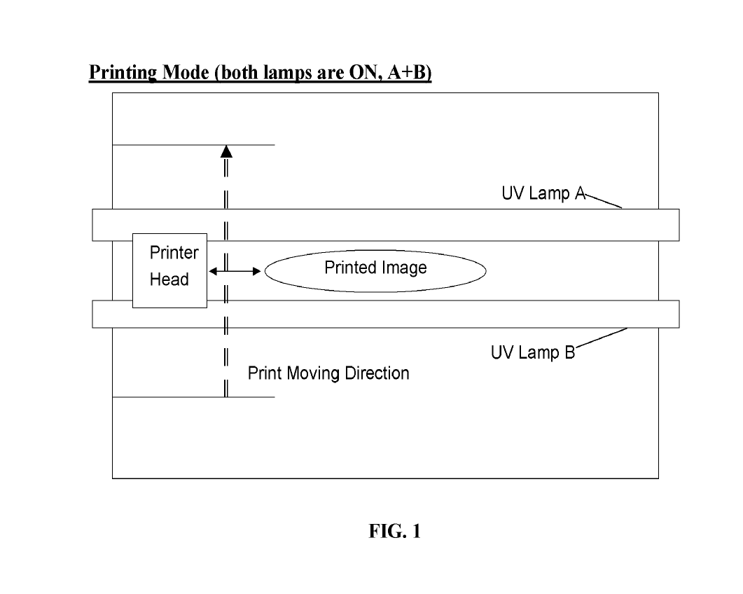

FIG: 1 is a diagram illustrating a normal printing and cure mode that may or may not utilize the principles of the invention. A dimmer device utilizing the principles of the invention, for example, may be used in the system of FIG. 1 to control the intensity of the light sources. As shown in FIG. 1, the light sources, depending on the embodiment, are an ultraviolet (U.V.) light source and disposed such that the print head can move independently of the light sources.

Heat is produced from the light source that lowers humidity to allow for curing of cationic ink, or other such compositions, in environments with a relative humidity above 60%. Heat produced from the light sources is kept low enough to keep surface temperature of a heat sensitive rigid media from deforming. In addition, the heat produced by the light sources can be controlled to prevent an ink jet print head from striking the media during printing. Typically the substrate is heat sensitive flexible or rigid media depending on the implementation of the invention. Such media easily deforms when exposed to heat and may deform to an extent where the printing head would make contact with the media. By controlling the heat of the light sources this potential defect is controlled.

As previously described, the light sources can generate ultraviolet light. It is within the embodiment of this invention to utilize one light source as well as multiple light sources in any orientation or structural form. In one embodiment, ultraviolet light intensity can be adjusted to produce gloss and matte finishes on flexible or rigid print media. Lower intensity is used for producing a gloss finish relative to a higher intensity used to produce matte finishes. The ultraviolet light intensity can be adjusted low enough to produce a more flexible ink that is less prone to cracking and more prone to media stretching. This flexibility feature is further described in the below examples.

The light sources can be, but are not limited to, low pressure mercury vapor lamps. These lamps can be used for curing cationic ink jet ink on flexible and rigid substrates. The advantages of using low pressure mercury vapor lamps include use for lower cost, higher life, lower power density and subsequent heat generation, and less susceptibility to failure from contact with impurities such as oil on ones skin that transfers to the quart tubing after touching the quartz tube with a finger.

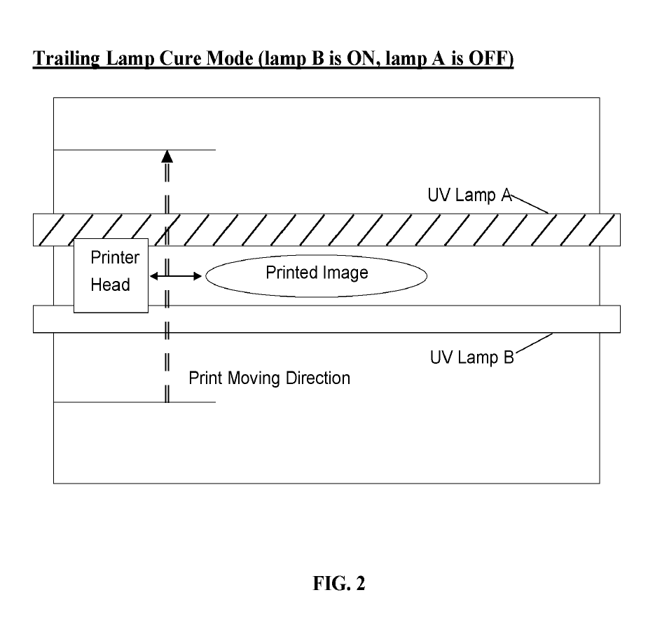

FIG. 2 is a diagram illustrating a leading lamp cure mode utilizing the principles of the invention.

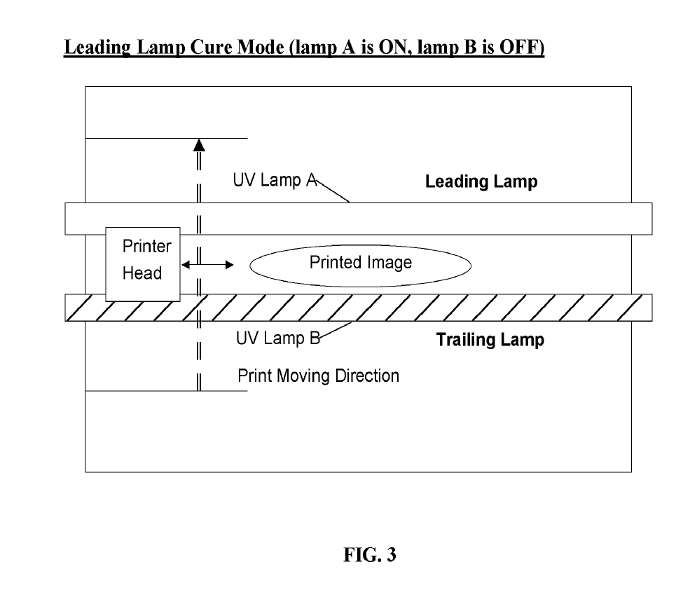

FIG. 3 is a diagram illustrating a trailing cure mode utilizing the principles of the invention.

### Examples

The following examples analyze the cure response, tape test, and extension test of cationic Gerber Cat ink with leading lamp, trailing lamp, and both lamp in Davinci printer for flexibility. Evaluated were the flexibility and performance of printed samples with different cure method and also on different vinyl substrates. Also evaluated were the changing the performance of each ink and over time as well.

Materials and Equipment
DaVinci Printer in lab, printing mode as 200% load, no delay
Using Inks: CMYK (lot#6061) GERBER CAT Cationic Ink
Substrate: 3M 220 white, IJ180CV2-10, IP2517 (Image Perfect Media, 4 mil cast)
   The lamp system has been adjusted like following diagrams for different cure conditions.

Measure Preparation

All vinyl substrates were printed under same conditions without change of intensity or speed (200% ink load, no delay) except lamp options. For evaluation test, each printed sample was tested within 1 hour the cure response, tape test, and extension test. After that same tests were executed with 1 day, 2 day, 7 day, 14 day and 21 day, to observe any performance changing over time. As reference, it was taken the samples without expose of UV light (Dark Mode) for extension test and raw vinyl substrates without ink as well.

TABLE A
Substrate, Print Mode, Color, and Test Time/Method Used.

| Substrate | Print Mode | Printed Color | Test Time/Method |
|---|---|---|---|
| 3M 220 White, | Raw material* | Each sample | Finger tip/tape |
| IJ 180 CV2-10, | (no print) | for Cyan, | test, extension |
| IP2517 cast | Dark Mode* | Magenta, | test for 1 h, 1, |
| | Leading lamp | Yellow and | 2, 7, 14, and 21 |
| | Trailing lamp | Black | day for each sample |
| | Normal | | |
| | (both lamp) | | |

*Only tested for extension

Extension Test Procedure
1. Used paper cutter, cut samples to ½ inches in width and cut several ½ and 1-inch pieces of paper. These paper used under the clamp ends.
2. Peeled the printed vinyl sample off the backing and apply one of the folded paper shims to its end section. With the top clamp removed from the fixture place the sample squarely on top of the left fixture piece. Laid the left clamp on top of the sample and with the teeth aligned hand tighten the bolts.
3. Tighten the bolts on the left side with the wrench. Set the micrometer to zero. Placed pieces of the ½ inches by paper on the top and bottom side of the sample in the teeth area of the right side clamp.
4. Slowly pulled the sample to tighten the fixture against the Micrometer and applied slight pressure attach the right side clamp to align the teeth and tighten the bolts with the tool.
5. Used the caliper to take a measurement of the starting gap length. This is the initial gap length value before stretching and recorded in the spreadsheet.
6. Placed the fixture under the camera and focus the on the vinyl along the sample edge. Slowly turned the micrometer while watching the vinyl sample. Slide the fixture around to view different areas of the sample, most times the early cracks form closest to the ends.
7. The initial cracks were when the sample just started to crack. Recorded the initial crack.
8. Continued rotating the micrometer until the beginning of lots of cracks. Measured the length of the sample extended and record the major crack in the data sheet.
9. After recorded the major crack, kept rotating the micrometer until the sample break, measured the length of the sample break and record the break in the data sheet.
10. The percentage calculation of the initial cracking is initial cracking divided by gap length, the percentage of major cracking is major cracking length divided by gap length, and the percentage of break cracking is break length divided by the gap length.

Tape Test Procedure
1. Used the Scotch tape, cut 2 inches long, and stick the tape toward the sample ink on the coroplast. The tape must fully stick to the sample ink.
2. Peeled the tape off quickly with hand and checked with the sample ink. Record the percentage of the ink that taped off
3. Repeated the test at least twice at different area to make sure the accuracy.
4. Reference of Tape Test Table below.

All detailed results are summarized in APPENDIX I

### Example 1

### Raw Material Extension Test and Dark Mode Samples as Reference

Before we started to compare with other printed samples, we would make sure that UV irradiation has any effect to vinyl material. In order to see this effect we did all 3 vinyl substrates extension test with UV under same condition like our printing modes and the results are shown in the following table.

As we expected, property of all vinyl substrates are not really impacted by irradiation of any condition of UV light. Also we have printed the image on vinyl substrates without expose of UV light and just let to dry out under ambient light for 3 days and then tested for extension and adhesion.

TABLE 1
Raw vinyl substrate test with/without UV irradiation.

| | | | | Extension Test | |
|---|---|---|---|---|---|
| | | | | 1 | 2 |
| Substrate | Print Mode | Print Date/Time | Test Date/Time | break | break |
| 3M 220W | N/A (raw) | N/A | Aug. 24, 2007-1:24pm | >250% | >250% |
| | Leading Lamp | Aug. 21, 2007-2:00pm | Aug. 27, 2007-8:42am | 187.7% | 214.8% |
| | Trailing Lamp | Aug. 21, 2007-3:50pm | | 174.1% | 182.7% |
| | Both Lamp | Aug. 21, 2007-2:15pm | | 242.0% | >250% |
| IJ180CV2 | N/A (raw) | N/A | Aug. 24, 2007-1:30pm | >250% | >250% |
| | Leading Lamp | Aug. 23, 2007-11:27am | Aug. 27, 2007-8:55am | >250% | >250% |
| | Trailing Lamp | Aug. 23, 2007-11:33am | | 242.0% | >250% |
| | Both Lamp | Aug. 23, 2007-10:30am | | 244.2% | 209.9% |
| IP2517 | N/A (raw) | N/A | Aug. 24, 2007-1:36pm | >250% | >250% |
| Cast 4 Mil | Leading Lamp | Aug. 22, 2007-3:00pm | Aug. 27, 2007-9:18am | >250% | >250% |
| | Trailing Lamp | Aug. 22, 2007-2:50pm | | >250% | >250% |
| | Both Lamp | Aug. 23, 2007-11:15am | | >250% | >250% |

All vinyl substrates are turning to very soft with ink and extended over 250% (not break). Also there was no ink layer cracking observed during extension. But all images are bleeding between color line and surface was gloss. In fact the cationic ink was soaked in film and penetrated into the vinyl film and changed the original property of vinyl substrates. This would be indicator for our experiment that we need to figure out the way of curing the ink without lost of original film property.

TABLE 2
Properties of Dark mode printing samples on
different vinyl substrates (after 3 days)

| | | | | | Extension Test | |
|---|---|---|---|---|---|---|
| | | Color | Tape test | | 1 | 2 |
| Substrate | Print Date/Time | (#6061) | 1 | 2 | break | break |
| 3M 220W | Aug. 21, 2007-2:35pm | Cyan | 0% off | 0% off | >250% | >250% |
| | | Magenta | 0% off | 0% off | >250% | >250% |
| | | Yellow | 0% off | 0% off | >250% | >250% |
| | | Black | 0% off | 0% off | >250% | >250% |
| IJ180CV2 | Aug. 21, 2007-3:30pm | Cyan | 0% off | 0% off | >250% | >250% |
| | | Magenta | 0% off | 0% off | >250% | >250% |
| | | Yellow | 0% off | 0% off | >250% | >250% |
| | | Black | 0% off | 0% off | >250% | >250% |
| IP2517 | Aug. 22, 2007-3:25pm | Cyan | 0% off | 0% off | >250% | >250% |
| Cast 4 Mil | | Magenta | 0% off | 0% off | >250% | >250% |
| | | Yellow | 0% off | 0% off | >250% | >250% |
| | | Black | 0% off | 0% off | >250% | >250% |

### Example 2

### Comparison of Different Printing Mode on IJ180CV2

We have printed the ink images and cured as described 3 different modes. Cure response was very good with all 3 modes and all cured samples were passed with tape test for adhesion over 3 weeks period time. Also no bleeding was observed between printing lines.

There are two important performances that we want to test during extension experiment. One is the surface cracking of printed layer, which related with cured ink polymer property on vinyl substrate and other one would be the effect of raw material flexibility with cured ink as breaking property of vinyl substrates. Based on our previous experiment we have observed that cured vinyl film was flexible after direct cure, but this flexibility decreased over time and as result, the printed material is changed as brittle and we could not able to get the flexibility, what we want. Therefore it is also very important that we should monitor the extension property over time and could summarize as follow FIGS. 1 and 2 (All data are average value of CMYK colors)

We have observed very interesting point in this experiment that flexibility of cured samples was significantly increased with leading and trailing lamp mode. Generally the cured sample was flexible after cure directly for all 3 samples (over 60˜100%), then within 24 hours mostly getting brittle and rapidly lost this flexibility of range of 20˜30%. The flexibility of samples after 24 hours were not decreased very much and ˜10 to 20% over 3 weeks time period.

Overall very exciting discovers was that the flexibility of trailing mode was increased more than 30% to compare with both lamp mode (normal printing mode) and this flexibility maintained over 3 weeks time period.

As next, the film breaking property of leading/trailing mode was same pattern like cracking property (FIG. 2).

Usually the UV light intensity of those modes from two parallel lamps should be leading<trailing<both lamps and light dosage as well. The results have shown that slow cure process or low intensity of UV light may create more flexible. But sample performance with leading mode seems to be slightly weak and may need more time to print for completely through cure. We would suggest that the best cure condition would be with trailing lamp mode for flexibility.

This is very important for some special applications such like high performance car warp application, because for this application the cured vinyl substrates need at least ˜50% of flexibility to apply and the sample with trailing mode meet or exceed this requirement during both lamp mode failed after ˜1 week time period.

### Example 3

### Comparison of Different Substrates

We have extend this flexibility test for other vinyl substrates like 3M 220 white cast film (2 mil thickness) and IP2517 cast film with ˜4 mil thickness to compare with IJ180CV2. Those vinyl substrates are one of our target materials for cationic inkjet printer and we would see the effect with trailing mode cure. The total cracking and breaking results are in FIGS. 3 and 4.

Based on this experiment we could confirm the discovery with trailing lamp mode. For 3M 220 cast film has shown relative lower flexibility than IJ180CV2 with cationic ink, but results indicated that samples with trailing mode have definitely increased flexibility to compare with both lamp mode. Also it is observed between 3M 220 and IJ180CV2 that the tendency of rapid flexibility decreasing within 24 hours.

Other remarkable point was the IP2517 cast film, which has 4-mil thickness. It seems to be that this thickness has very little influence of getting brittle overtime and less effect of trailing lamp mode. Even both lamp mode (normal cure process) has shown the excellent extension property and adhesion (tape test) for real application.

### Example 4

### Comparison of CMYK Color Block Image Property

Now, we would compare the flexibility between 4 colors, which we used as CMYK block images. We will compare the cracking of CMYK color samples over 3 weeks as follow FIG. 5.

As results, we can tell that generally there were not significant differences between colors, except Magenta over time. At first, after direct cure (FIG. 5-a), all CMYK samples has shown very similar properties within 10˜20% extension measure difference, which could be within tolerance parameters. After 24 hours (FIG. 5-b), all values were same parameter except Magenta color, which has shown relative higher flexibility than other colors. This effect of Magenta was kept over 3 weeks time period on 3M 220 and IJ180CV2 vinyl substrates (FIG. 5-c).

It may cause interaction between magenta pigment and polymer network (crosslink) and also relatively slow cure response due to magenta ink to compare with other colors. But this difference was not very big (within 20%) and may be do not influence much in case real printing. To compare with 3M 220 or IJ180CV2, IP2517 has shown less difference between colors.

More concern would be the color of low cracking/breaking value (yellow or cyan in both lamp mode), because it could cause the easy breaking of whole vinyl film, when the film stressed.

For car wrap application we would need at least 50% flexibility of printed substrates. In FIG. 6 we can easily make a decision which vinyl would be work.

As we could see in FIGS. 6-a and 6-b, the both lamp mode of 3M 220 has shown that flexibility of all CMYK colors after 1 day was under 50% extension, i.e. 3M 220 vinyl film would be too brittle for use. By IJ180CV2 with both lamp mode was better, but not quiet good enough for 50% flexibility after 3 weeks (cyan and yellow). The best choice would be the IJ180CV2 with Trailing lamp mode (FIG. 6-c) and the IP2517 (FIG. 6-d). All CMYK colors on those vinyl substrates were more than 60˜70% flexibility, even after 3 weeks.

Dark cure process is well known procedure in cationic ink chemistry and was negatively effect when ink printed and cured on vinyl substrates as like getting brittle over time.

We have found the new way to solve the flexibility issue on vinyl substrates with optimizing of our Solara Ion printer. This method is very simple to apply in printer without significant hardware change and without current cationic ink formulation, but very effective to cure the ink without losing of ink resolution and performance.

Simple solution would be a using of 4 mil thick IP2517 (Image Perfect Media) for real application like car wrapping. With this cast film we do not need change anything in printer and create very flexible film with normal print method (cracking >60%, Breaking >200%). It is possible that a new profile of printer is needed in order to increase the printing quality.

As we have shown in our results, IJ180CV2 is recommended for car wrap application with Trailing mode, where real application requires thin film like 2 mil thickness. The flexibility of cured film was increased more than 60˜90% to compare with 30˜50% of normal cure (Both lamp mode) after curing. Also we could have potential surface control of cured layer with light intensity and dosage from matt to gloss.

### APPENDIX I: All Summarized Experimental Data

Material: 3M 220W Time Duration: One Hour

| Print | | | Colors | | | Initial | Major | | Initial | Major | |
|---|---|---|---|---|---|---|---|---|---|---|---|
| Mode | Print Date/Time | Test Date/Time | (#6061) | 1 | 2 | Crack | Crack | Break | Crack | Crack | Break |
| Leading | Aug. 21, 2007-1:50pm | Aug. 21, 2007-2:17pm | Cyan | 0% off | 0% off | 53.1% | 65.4% | 249.4% | 53.1% | 67.9% | 172.8% |
| Lamp | | Aug. 21, 2007-2:12pm | Magenta | 0% off | 0% off | 49.4% | 58.0% | 209.9% | 40.7% | 49.4% | 176.5% |
| | | Aug. 21, 2007-2:21pm | Yellow | 0% off | 0% off | 43.2% | 55.6% | 86.4% | 38.3% | 56.8% | 74.1% |
| | | Aug. 21, 2007-2:28pm | Black | 0% off | 0% off | 33.3% | 45.7% | 207.4% | 35.8% | 46.9% | 129.6% |
| Trailing | Aug. 21, 2007-2:25pm | Aug. 21, 2007-2:46pm | Cyan | 1% off | 1% off | 75.3% | 95.1% | 204.9% | 82.7% | 91.4% | 222.2% |
| Lamp | | Aug. 21, 2007-2:53pm | Magenta | 0% off | 0% off | 61.7% | 81.5% | 232.0% | 65.4% | 84.0% | 227.2% |
| | | Aug. 21, 2007-3:02pm | Yellow | 0% off | 0% off | 86.4% | 103.7% | 238.3% | 88.9% | 100.0% | 238.3% |
| | | Aug. 21, 2007-3:08pm | Black | 0% off | 0% off | 65.4% | 90.1% | 144.4% | 70.4% | 96.3% | 209.9% |
| Both | Aug. 21, 2007-3:15pm | Aug. 21, 2007-3:30pm | Cyan | 0% off | 0% off | 46.9% | 60.5% | 71.6% | 55.6% | 69.1% | 87.7% |
| Lamp | | Aug. 21, 2007-3:36pm | Magenta | 0% off | 0% off | 64.2% | 74.1% | 124.7% | 63.0% | 72.8% | 108.6% |
| | | Aug. 21, 2007-3:41pm | Yellow | 0% off | 0% off | 50.6% | 61.7% | 64.2% | 49.4% | 55.6% | 66.7% |
| | | Aug. 21, 2007-3:48pm | Black | 0% off | 0% off | 46.9% | 56.8% | 70.4% | 45.7% | 59.3% | 67.9% |

All samples were surface cured after and over time. For the trailing lamp sample, color cyan had 1% ink taped off. All other samples were passed tape test. For extension test, both lamp samples were less flexible and easier to crack compared with leading lamp and trailing lamp. The trailing lamp samples were most flexible compared with other samples. By the color, the color black was less flexible than other colors, and color magenta was most flexible.

Material: IJ180CV2 Time Duration: One Hour

| Print | | | Colors | | | Initial | Major | | Initial | Major | |
|---|---|---|---|---|---|---|---|---|---|---|---|
| Mode | Print Date/Time | Test Date/Time | (#6061) | 1 | 2 | Crack | Crack | Break | Crack | Crack | Break |
| Leading | Aug. 22, 2007-11:10am | Aug. 22, 2007-11:32am | Cyan | 0% off | 0% off | 60.5% | 71.6% | 256.8% | 63.0% | 76.5% | 240.7% |
| Lamp | | Aug. 22, 2007-11:40am | Magenta | 0% off | 0% off | 49.4% | 64.2% | 177.8% | 46.9% | 63.0% | 193.8% |
| | | Aug. 22, 2007-11:45am | Yellow | 0% off | 0% off | 64.2% | 77.8% | 161.7% | 63.0% | 71.6% | 108.6% |
| | | Aug. 22, 2007-11:51am | Black | 0% off | 0% off | 38.3% | 51.9% | 207.4% | 43.2% | 59.3% | 167.9% |
| Trailing | Aug. 22, 2007-10:50am | Aug. 22, 2007-11:01am | Cyan | 0% off | 0% off | 86.4% | 98.8% | 195.1% | 93.8% | 101.2% | 256.8% |
| Lamp | | Aug. 22, 2007-11:10am | Magenta | 0% off | 0% off | 82.7% | 97.5% | 180.2% | 75.3% | 98.8% | 245.7% |
| | | Aug. 22, 2007-11:16am | Yellow | 0% off | 0% off | 71.6% | 86.4% | 218.5% | 80.2% | 91.4% | 256.6% |
| | | Aug. 22, 2007-11:22am | Black | 0% off | 0% off | 67.9% | 86.4% | 175.3% | 80.2% | 95.1% | 221.0% |
| Both | Aug. 22, 2007-10:00am | Aug. 22, 2007-10:14am | Cyan | 0% off | 0% off | 53.1% | 64.2% | 82.7% | 55.6% | 63.0% | 77.8% |
| Lamp | | Aug. 22, 2007-10:20am | Magenta | 0% off | 0% off | 63.0% | 74.1% | 130.9% | 69.1% | 80.2% | 208.6% |
| | | Aug. 22, 2007-10:28am | Yellow | 0% off | 0% off | 58.0% | 67.9% | 76.5% | 49.4% | 54.3% | 60.5% |
| | | Aug. 22, 2007-10:32am | Black | 0% off | 0% off | 56.8% | 70.4% | 151.9% | 61.7% | 72.8% | 160.5% |

All the samples were surface cured after and over time. And all the samples were passed tape test. For the extension test, both lamp samples were less flexible and easier to crack compared with leading lamp and trailing lamp. The trailing lamp samples were most flexible compared with other samples. By the color, the color black was less flexible than other colors.

Material: IP2517 cast Time Duration: One Hour

| Print | | | Colors | | | Initial | Major | | Initial | Major | |
|---|---|---|---|---|---|---|---|---|---|---|---|
| Mode | Print Date/Time | Test Date/Time | (#6061) | 1 | 2 | Crack | Crack | Break | Crack | Crack | Break |
| Leading | Aug. 23, 2007-11:00am | Aug. 23, 2007-11:32am | Cyan | 0% off | 0% off | 55.6% | 65.4% | 172.8% | 55.6% | 64.2% | 245.7% |
| Lamp | | Aug. 23, 2007-11:39am | Magenta | 0% off | 0% off | 69.1% | 88.9% | 201.2% | 56.8% | 71.6% | 239.5% |
| | | Aug. 23, 2007-11:45am | Yellow | 0% off | 0% off | 71.6% | 84.0% | >250% | 76.5% | 90.1% | >250% |
| | | Aug. 23, 2007-11:51am | Black | 0% off | 0% off | 59.3% | 75.3% | >250% | 61.7% | 71.6% | >250% |
| Trailing | Aug. 23, 2007-10:50am | Aug. 23, 2007-11:02am | Cyan | 0% off | 0% off | 70.4% | 80.2% | >250% | 84.0% | 98.8% | >250% |
| Lamp | | Aug. 23, 2007-11:09am | Magenta | 0% off | 0% off | 76.5% | 93.8% | >250% | 75.3% | 104.9% | >250% |
| | | Aug. 23, 2007-11:15am | Yellow | 0% off | 0% off | 92.6% | 104.9% | >250% | 77.8% | 97.5% | >250% |
| | | Aug. 23, 2007-11:22am | Black | 0% off | 0% off | 74.1% | 92.6% | >250% | 75.3% | 87.7% | >250% |
| Both | Aug. 22, 2007-2:22pm | Aug. 22, 2007-2:35pm | Cyan | 0% off | 0% off | 54.3% | 69.1% | 256.8% | 61.7% | 71.6% | 256.8% |
| Lamp | | Aug. 22, 2007-2:43pm | Magenta | 0% off | 0% off | 66.7% | 80.2% | 256.8% | 74.1% | 85.2% | 256.8% |
| | | Aug. 22, 2007-2:49pm | Yellow | 0% off | 0% off | 84.0% | 106.2% | >250% | 87.7% | 104.9% | >250% |
| | | Aug. 22, 2007-2:57pm | Black | 0% off | 0% off | 56.8% | 75.3% | >250% | 61.7% | 79.0% | >250% |

All the samples were surface cured after and over time. All the samples were passed tape test. For extension test, both lamp samples were less flexible compared with leading lamp and trailing lamp. And the trailing lamp samples were most flexible compared with other samples. By the color, the color black was less flexible than other colors, and color magenta was most flexible.

Material: 3M 220W Time Duration: One Day

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 21, 2007- | Aug. 22, 2007- | Cyan | 0% | 0% | 44.4% | 60.5% | 79.0% | 37.0% | 54.3% | 71.6% |
| Lamp | 1:50 pm | 3:55 pm | | off | off | | | | | | |
| | | Aug. 22, 2007- | Magenta | 0% | 0% | 51.9% | 66.7% | 148.1% | 53.1% | 66.7% | 171.6% |
| | | 4:01 pm | | off | off | | | | | | |
| | | Aug. 22, 2007- | Yellow | 0% | 0% | 34.6% | 42.0% | 46.9% | 28.4% | 39.5% | 43.2% |
| | | 4:07 pm | | off | off | | | | | | |
| | | Aug. 22, 2007- | Black | 0% | 0% | 27.2% | 35.8% | 77.8% | 24.7% | 37.0% | 80.2% |
| | | 4:11 pm | | off | off | | | | | | |
| Trailing | Aug. 21, 2007- | Aug. 22, 2007- | Cyan | 0% | 0% | 51.9% | 65.4% | 91.4% | 49.4% | 60.5% | 74.1% |
| Lamp | 2:25 pm | 3:22 pm | | off | off | | | | | | |
| | | Aug. 22, 2007- | Magenta | 0% | 0% | 64.2% | 86.4% | 138.3% | 56.8% | 87.7% | 140.7% |
| | | 3:31 pm | | off | off | | | | | | |
| | | Aug. 22, 2007- | Yellow | 0% | 0% | 50.6% | 66.7% | 82.7% | 56.8% | 66.7% | 72.8% |
| | | 3:38 pm | | off | off | | | | | | |
| | | Aug. 22, 2007- | Black | 0% | 0% | 49.4% | 66.7% | 80.2% | 53.1% | 59.3% | 75.3% |
| | | 3:43 pm | | off | off | | | | | | |
| Both | Aug. 21, 2007- | Aug. 22, 2007- | Cyan | 0% | 0% | 24.7% | 29.6% | 30.9% | 32.1% | 37.0% | 40.7% |
| Lamp | 3:15 pm | 4:20 pm | | off | off | | | | | | |
| | | Aug. 22, 2007- | Magenta | 0% | 0% | 17.3% | 35.8% | 35.8% | 19.8% | 39.5% | 39.5% |
| | | 4:24 pm | | off | off | | | | | | |
| | | Aug. 22, 2007- | Yellow | 0% | 0% | 27.2% | 27.2% | 27.2% | 30.9% | 30.9% | 30.9% |
| | | 4:29 pm | | off | off | | | | | | |
| | | Aug. 22, 2007- | Black | 0% | 0% | 24.7% | 30.9% | 43.2% | 28.4% | 34.6% | 42.0% |
| | | 4:35 pm | | off | off | | | | | | |

After one day, all the samples were passed tape test. For extension test, both lamp samples were easier to crack than other samples. Especially for color magenta and yellow, the crack was not detectable. Compared with one hour samples, the one day samples were less flexible and easier to crack.

Material: IJ180CV2 Time Duration: One Day

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 22, 2007- | Aug. 23, 2007- | Cyan | 0% | 0% | 50.6% | 61.7% | 77.8% | 48.1% | 56.8% | 84.0% |
| Lamp | 11:10 am | 10:25 am | | off | off | | | | | | |
| | | Aug. 23, 2007- | Magenta | 0% | 0% | 63.0% | 72.8% | 164.2% | 58.0% | 70.4% | 158.0% |
| | | 10:36 am | | off | off | | | | | | |
| | | Aug. 23, 2007- | Yellow | 0% | 0% | 43.2% | 54.3% | 64.2% | 39.5% | 53.1% | 58.0% |
| | | 10:41 am | | off | off | | | | | | |
| | | Aug. 23, 2007- | Black | 0% | 0% | 27.2% | 43.2% | 81.5% | 24.7% | 42.0% | 82.7% |
| | | 10:46 am | | off | off | | | | | | |
| Trailing | Aug. 22, 2007- | Aug. 23, 2007- | Cyan | 0% | 0% | 63.0% | 79.0% | 90.1% | 54.3% | 75.3% | 87.7% |
| Lamp | 10:50 am | 9:16 am | | off | off | | | | | | |
| | | Aug. 23, 2007- | Magenta | 0% | 0% | 74.1% | 82.7% | 98.8% | 77.8% | 85.2% | 122.2% |
| | | 9:22 am | | off | off | | | | | | |
| | | Aug. 23, 2007- | Yellow | 0% | 0% | 65.4% | 76.5% | 86.4% | 64.2% | 76.5% | 84.0% |
| | | 9:28 am | | off | off | | | | | | |
| | | Aug. 23, 2007- | Black | 0% | 0% | 66.7% | 74.1% | 84.0% | 61.7% | 71.6% | 86.4% |
| | | 9:35 am | | off | off | | | | | | |
| Both | Aug. 22, 2007- | Aug. 23, 2007- | Cyan | 0% | 0% | 24.7% | 37.0% | 44.4% | 28.4% | 38.3% | 50.6% |
| Lamp | 10:00 am | 8:49 am | | off | off | | | | | | |
| | | Aug. 23, 2007- | Magenta | 0% | 0% | 48.1% | 60.5% | 66.7% | 48.1% | 56.8% | 65.4% |
| | | 8:53 am | | off | off | | | | | | |
| | | Aug. 23, 2007- | Yellow | 0% | 0% | 29.6% | 38.3% | 42.0% | 37.0% | 42.0% | 48.1% |
| | | 9:00 am | | off | off | | | | | | |
| | | Aug. 23, 2007- | Black | 0% | 0% | 44.4% | 50.6% | 63.0% | 43.2% | 50.6% | 60.5% |
| | | 9:05 am | | off | off | | | | | | |

After one day, all the samples were passed tape test. For extension test, both lamp samples were less flexible. And the trailing lamp samples were most flexible compared with other samples. Compared with one hour samples, the one day samples were easier to crack and less flexible than one hour samples.

Material: IP2517 cast Time Duration: One Day

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 23, 2007- | Aug. 24, 2007- | Cyan | 0% | 0% | 79.0% | 98.8% | 235.8% | 66.7% | 88.9% | 251.9% |
| Lamp | 11:00 am | 10:14 am | | off | off | | | | | | |
| | | Aug. 24, 2007- | Magenta | 0% | 0% | 86.4% | 122.2% | >250% | 80.2% | 102.5% | >250% |
| | | 11:22 am | | off | off | | | | | | |
| | | Aug. 24, 2007- | Yellow | 0% | 0% | 88.9% | 112.3% | >250% | 85.2% | 111.1% | >250% |
| | | 10:30 am | | off | off | | | | | | |
| | | Aug. 24, 2007- | Black | 0% | 0% | 69.1% | 88.9% | >250% | 70.4% | 86.4% | >250% |
| | | 10:37 am | | off | off | | | | | | |
| Trailing | Aug. 23, 2007- | Aug. 24, 2007- | Cyan | 0% | 0% | 87.7% | 98.8% | >250% | 82.7% | 91.4% | >250% |
| Lamp | 10:50 am | 9:13 am | | off | off | | | | | | |
| | | Aug. 24, 2007- | Magenta | 0% | 0% | 96.3% | 111.1% | >250% | 106.2% | 116.0% | >250% |
| | | 9:21 am | | off | off | | | | | | |
| | | Aug. 24, 2007- | Yellow | 0% | 0% | 90.1% | 106.2% | >250% | 90.1% | 103.7% | >250% |
| | | 9:20 am | | off | off | | | | | | |
| | | Aug. 24, 2007- | Black | 0% | 0% | 64.2% | 77.8% | 240.7% | 64.2% | 82.7% | >250% |
| | | 9:36 am | | off | off | | | | | | |
| Both | Aug. 22, 2007- | Aug. 23, 2007- | Cyan | 0% | 0% | 46.9% | 56.8% | 196.3% | 42.0% | 54.3% | 201.2% |
| Lamp | 2:22 pm | 1:43 pm | | off | off | | | | | | |
| | | Aug. 23, 2007- | Magenta | 0% | 0% | 60.5% | 71.6% | >250% | 63.0% | 75.3% | >250% |
| | | 1:50 pm | | off | off | | | | | | |
| | | Aug. 23, 2007- | Yellow | 0% | 0% | 77.8% | 96.3% | 180.2% | 71.6% | 84.0% | 196.3% |
| | | 1:57 pm | | off | off | | | | | | |
| | | Aug. 23, 2007- | Black | 0% | 0% | 51.9% | 61.7% | 237.0% | 55.6% | 65.4% | 224.7% |
| | | 2:03 pm | | off | off | | | | | | |

After one day, all the 250 W samples were passed tape test. For the extension test, both lamp samples were less flexible and easier to crack than others. The trailing lamp samples were most flexible. For leading and trailing lamps, the color black was less flexible. For both lamp samples, the cyan and black were less flexible. Compared with one hour samples, the one day samples were easier to crack and less flexible than one hour samples.

Material: 3M 220W Time Duration: Two Days

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 21, 2007- | Aug. 23, 2007- | Cyan | 0% | 0% | 34.6% | 45.7% | 63.0% | 42.0% | 51.9% | 71.6% |
| Lamp | 1:50 pm | 2:53 pm | | off | off | | | | | | |
| | | Aug. 23, 2007- | Magenta | 0% | 0% | 51.9% | 65.4% | 142.0% | 54.3% | 64.2% | 122.2% |
| | | 2:59 pm | | off | off | | | | | | |
| | | Aug. 23, 2007- | Yellow | 0% | 0% | 22.2% | 30.9% | 37.0% | 19.8% | 32.1% | 40.7% |
| | | 3:06 pm | | off | off | | | | | | |
| | | Aug. 23, 2007- | Black | 0% | 0% | 22.2% | 34.6% | 76.5% | 19.8% | 30.9% | 80.2% |
| | | 3:14 pm | | off | off | | | | | | |
| Trailing | Aug. 21, 2007- | Aug. 23, 2007- | Cyan | 0% | 0% | 44.4% | 55.6% | 74.1% | 54.3% | 61.7% | 84.0% |
| Lamp | 2:25 pm | 3:30 pm | | off | off | | | | | | |
| | | Aug. 23, 2007- | Magenta | 0% | 0% | 65.4% | 80.2% | 134.6% | 75.3% | 85.2% | 114.8% |
| | | 3:35 pm | | off | off | | | | | | |
| | | Aug. 23, 2007- | Yellow | 0% | 0% | 59.3% | 67.9% | 74.1% | 61.7% | 75.3% | 79.0% |
| | | 3:44 pm | | off | off | | | | | | |
| | | Aug. 23, 2007- | Black | 0% | 0% | 39.5% | 56.8% | 76.5% | 49.4% | 61.7% | 76.5% |
| | | 3:50 pm | | off | off | | | | | | |
| Both | Aug. 21, 2007- | Aug. 23, 2007- | Cyan | 0% | 0% | 18.5% | 21.0% | 23.5% | 16.0% | 19.8% | 23.5% |
| Lamp | 3:15 pm | 4:09 pm | | off | off | | | | | | |
| | | Aug. 23, 2007- | Magenta | 0% | 0% | 38.3% | 40.7% | 40.7% | 37.0% | 50.5% | 50.6% |
| | | 4:14 pm | | off | off | | | | | | |
| | | Aug. 23, 2007- | Yellow | 0% | 0% | 34.6% | 34.6% | 34.6% | 29.6% | 29.6% | 29.6% |
| | | 4:19 pm | | off | off | | | | | | |
| | | Aug. 23, 2007- | Black | 0% | 0% | 18.5% | 29.6% | 30.9% | 21.0% | 32.1% | 34.6% |
| | | 4:23 pm | | off | off | | | | | | |

After two days, all the samples were passed tape test. For the extension test, still both lamp samples were easier to crack and less flexible compared with other samples. And trailing lamp samples were most flexible. For leading lamp, the yellow and black were less flexible. For trailing and both lamp, the cyan and black were less flexible. Compared with one hour and one day samples, the two days samples were little easier to crack and less flexible.

Material: IJ180CV2 Time Duration: Two Days

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 22, 2007- | Aug. 24, 2007- | Cyan | 0% | 0% | 44.4% | 56.8% | 82.7% | 54.3% | 63.0% | 77.8% |
| Lamp | 11:10 am | 1:02 pm | | off | off | | | | | | |
| | | Aug. 24, 2007- | Magenta | 0% | 0% | 48.1% | 60.5% | 193.8% | 59.3% | 71.6% | 171.6% |
| | | 1:07 pm | | off | off | | | | | | |
| | | Aug. 24, 2007- | Yellow | 0% | 0% | 37.0% | 46.9% | 63.0% | 35.8% | 48.1% | 61.7% |
| | | 1:14 pm | | off | off | | | | | | |
| | | Aug. 24, 2007- | Black | 0% | 0% | 34.6% | 44.4% | 87.7% | 34.6% | 45.7% | 98.8% |
| | | 1:19 pm | | off | off | | | | | | |
| Trailing | Aug. 22, 2007- | Aug. 24, 2007- | Cyan | 0% | 0% | 59.3% | 67.9% | 81.5% | 58.0% | 67.9% | 80.2% |
| Lamp | 10:50 am | 1:46 pm | | off | off | | | | | | |
| | | Aug. 24, 2007- | Magenta | 0% | 0% | 71.6% | 80.2% | 106.2% | 77.8% | 90.1% | 124.7% |
| | | 1:52 pm | | off | off | | | | | | |
| | | Aug. 24, 2007- | Yellow | 0% | 0% | 65.4% | 76.5% | 90.1% | 63.0% | 71.6% | 84.0% |
| | | 1:59 pm | | off | off | | | | | | |
| | | Aug. 24, 2007- | Black | 0% | 0% | 55.6% | 69.1% | 82.7% | 60.5% | 69.1% | 88.9% |
| | | 2:05 pm | | off | off | | | | | | |
| Both | Aug. 22, 2007- | Aug. 24, 2007- | Cyan | 0% | 0% | 24.7% | 29.6% | 29.6% | 30.9% | 37.0% | 45.7% |
| Lamp | 10:00 am | 2:25 pm | | off | off | | | | | | |
| | | Aug. 24, 2007- | Magenta | 0% | 0% | 49.4% | 55.6% | 56.8% | 59.3% | 64.2% | 74.1% |
| | | 2:30 pm | | off | off | | | | | | |
| | | Aug. 24, 2007- | Yellow | 0% | 0% | 37.0% | 43.2% | 44.4% | 38.3% | 45.7% | 50.6% |
| | | 2:34 pm | | off | off | | | | | | |
| | | Aug. 24, 2007- | Black | 0% | 0% | 30.9% | 44.4% | 50.6% | 34.6% | 45.7% | 56.8% |
| | | 2:39 pm | | off | off | | | | | | |

After two days, the IJ180CV2 samples were passed tape test. For the extension test, the both lamp samples were easier to crack and less flexible than others. And trailing lamp was most flexible than others. Color black was less flexible compared with other colors. The two days samples were very close to one day samples, no dramatically changing.

Material: IP2517 cast Time Duration: Two Days

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Both | Aug. 22, 2007- | Aug. 24, 2007- | Cyan | 0% | 0% | 46.9% | 55.6% | 204.9% | 45.7% | 56.8% | 172.8% |
| Lamp | 2:22 pm | 3:02 pm | | off | off | | | | | | |
| | | Aug. 24, 2007- | Magenta | 0% | 0% | 58.0% | 75.3% | >250% | 67.9% | 81.5% | >250% |
| | | 3:09 pm | | off | off | | | | | | |
| | | Aug. 24, 2007- | Yellow | 0% | 0% | 63.0% | 77.8% | 209.8% | 69.1% | 91.4% | 186.4% |
| | | 3:15 pm | | off | off | | | | | | |
| | | Aug. 24, 2007- | Black | 0% | 0% | 53.1% | 66.7% | >250% | 44.4% | 55.6% | >250% |
| | | 3:21 pm | | off | off | | | | | | |

After two days, the 250 W both lamp samples were passed tape test. For the extension test, both lamp samples were very flexible. The color cyan and black were easier to crack than others.

Material: 3M 220W Time Duration: One Week

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 21, 2007- | Aug. 28, 2007- | Cyan | 0% | 0% | 25.9% | 44.4% | 70.4% | 27.2% | 40.7% | 54.3% |
| Lamp | 1:50 pm | 8:50 am | | off | off | | | | | | |
| | | Aug. 28, 2007- | Magenta | 0% | 0% | 55.6% | 64.2% | 103.7% | 51.9% | 61.7% | 108.6% |
| | | 8:58 am | | off | off | | | | | | |
| | | Aug. 28, 2007- | Yellow | 0% | 0% | 30.9% | 38.3% | 39.5% | 25.9% | 32.1% | 37.0% |
| | | 9:04 am | | off | off | | | | | | |
| | | Aug. 28, 2007- | Black | 0% | 0% | 32.1% | 39.5% | 66.7% | 28.4% | 35.8% | 76.5% |
| | | 9:09 am | | off | off | | | | | | |
| Trailing | Aug. 21, 2007- | Aug. 28, 2007- | Cyan | 0% | 0% | 35.8% | 46.9% | 54.3% | 38.3% | 48.1% | 61.7% |
| Lamp | 2:25 pm | 9:14 am | | off | off | | | | | | |
| | | Aug. 28, 2007- | Magenta | 0% | 0% | 67.9% | 75.3% | 93.8% | 65.4% | 71.6% | 87.7% |
| | | 9:20 am | | off | off | | | | | | |
| | | Aug. 28, 2007- | Yellow | 0% | 0% | 59.3% | 63.0% | 72.8% | 50.6% | 56.8% | 71.6% |
| | | 9:26 am | | off | off | | | | | | |
| | | Aug. 28, 2007- | Black | 0% | 0% | 49.4% | 58.0% | 75.3% | 40.7% | 49.4% | 66.7% |
| | | 9:35 am | | off | off | | | | | | |
| Both | Aug. 21, 2007- | Aug. 28, 2007- | Cyan | 0% | 0% | 19.8% | 22.2% | 27.2% | 17.3% | 19.8% | 25.9% |
| Lamp | 3:15 pm | 9:40 am | | off | off | | | | | | |
| | | Aug. 28, 2007- | Magenta | 0% | 0% | 38.3% | 44.4% | 51.9% | 27.2% | 35.8% | 35.8% |
| | | 9:45 am | | off | off | | | | | | |
| | | Aug. 28, 2007- | Yellow | 0% | 0% | 23.5% | 29.6% | 29.6% | 23.5% | 25.9% | 25.9% |
| | | 9:50 am | | off | off | | | | | | |
| | | Aug. 28, 2007- | Black | 0% | 0% | 17.3% | 17.3% | 17.3% | 23.5% | 32.1% | 34.6% |
| | | 9:55 am | | off | off | | | | | | |

After one week, all the samples were passed tape test. For the extension test, both lamp samples were easier to crack and less flexible. And trailing lamp was most flexible. Compared with two days samples, the one week samples were more flexible. No dramatically changing. The percentage of breaking point had been increased.

Material: IJ180CV2 Time Duration: One Week

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 22, 2007- | Aug. 29, 2007- | Cyan | 0% | 0% | 42.0% | 55.6% | 72.8% | 50.6% | 61.7% | 91.4% |
| Lamp | 11:10 am | 8:50 am | | off | off | | | | | | |
| | | Aug. 29, 2007- | Magenta | 0% | 0% | 61.7% | 75.3% | 123.5% | 65.4% | 80.2% | 140.7% |
| | | 8:57 am | | off | off | | | | | | |
| | | Aug. 29, 2007- | Yellow | 0% | 0% | 37.0% | 50.6% | 56.8% | 35.8% | 45.7% | 53.1% |
| | | 9:04 am | | off | off | | | | | | |
| | | Aug. 29, 2007- | Black | 0% | 0% | 46.9% | 55.6% | 92.6% | 39.5% | 49.4% | 96.3% |
| | | 9:10 am | | off | off | | | | | | |
| Trailing | Aug. 22, 2007- | Aug. 29, 2007- | Cyan | 0% | 0% | 65.3% | 61.7% | 67.9% | 53.1% | 63.0% | 70.4% |
| Lamp | 10:50 am | 9:20 am | | off | off | | | | | | |
| | | Aug. 29, 2007- | Magenta | 0% | 0% | 69.1% | 79.0% | 87.7% | 72.8% | 80.2% | 106.2% |
| | | 9:34 am | | off | off | | | | | | |
| | | Aug. 29, 2007- | Yellow | 0% | 0% | 59.3% | 66.7% | 75.3% | 61.7% | 70.4% | 76.5% |
| | | 9:38 am | | off | off | | | | | | |
| | | Aug. 29, 2007- | Black | 0% | 0% | 54.3% | 69.1% | 85.2% | 56.8% | 65.4% | 82.7% |
| | | 9:44 am | | off | off | | | | | | |
| Both | Aug. 22, 2007- | Aug. 29, 2007- | Cyan | 0% | 0% | 23.5% | 28.4% | 30.9% | 27.2% | 29.6% | 34.6% |
| Lamp | 10:00 am | 10:06 am | | off | off | | | | | | |
| | | Aug. 29, 2007- | Magenta | 0% | 0% | 43.2% | 50.6% | 58.0% | 45.7% | 53.1% | 56.8% |
| | | 10:11 am | | off | off | | | | | | |
| | | Aug. 29, 2007- | Yellow | 0% | 0% | 27.2% | 33.3% | 35.8% | 24.7% | 37.0% | 40.7% |
| | | 10:17 am | | off | off | | | | | | |
| | | Aug. 29, 2007- | Black | 0% | 0% | 40.7% | 50.6% | 60.5% | 38.3% | 46.9% | 48.1% |
| | | 10:25 am | | off | off | | | | | | |

After two weeks, all the samples were passed tape test. For the extension test, both lamp samples were less flexible and easier to crack. The trailing lamp samples were most flexible. Compared with two days samples, leading lamp samples and both lamp samples were more flexible than two days samples. The trailing lamp samples were less flexible than two days samples.

Material: IP2517 cast Time Duration: One Week

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 23, 2007- | Aug. 30, 2007- | Cyan | 0% | 0% | 82.7% | 111.1% | >250% | 81.5% | 109.9% | >250% |
| Lamp | 11:00 am | 8:57 am | | off | off | | | | | | |
| | | Aug. 30, 2007- | Magenta | 0% | 0% | 111.1% | 159.3% | >250% | 135.8% | 169.1% | >250% |
| | | 9:05 am | | off | off | | | | | | |
| | | Aug. 30, 2007- | Yellow | 0% | 0% | 81.5% | 107.4% | >250% | 91.4% | 111.1% | >250% |
| | | 9:14 am | | off | off | | | | | | |
| | | Aug. 30, 2007- | Black | 0% | 0% | 86.4% | 103.7% | >250% | 81.5% | 101.2% | >250% |
| | | 9:20 am | | off | off | | | | | | |
| Trailing | Aug. 23, 2007- | Aug. 30, 2007- | Cyan | 0% | 0% | 84.0% | 100.0% | >250% | 84.0% | 103.7% | >250% |
| Lamp | 10:50 am | 9:30 am | | off | off | | | | | | |
| | | Aug. 30, 2007- | Magenta | 0% | 0% | 107.4% | 121.0% | >250% | 111.1% | 123.5% | >250% |
| | | 9:35 am | | off | off | | | | | | |
| | | Aug. 30, 2007- | Yellow | 0% | 0% | 81.5% | 104.9% | >250% | 90.1% | 108.6% | >250% |
| | | 9:41 am | | off | off | | | | | | |
| | | Aug. 30, 2007- | Black | 0% | 0% | 86.4% | 98.8% | >250% | 79.0% | 93.8% | >250% |
| | | 9:47 am | | off | off | | | | | | |
| Both | Aug. 22, 2007- | Aug. 29, 2007- | Cyan | 0% | 0% | 45.7% | 59.3% | 197.5% | 43.2% | 55.6% | 187.7% |
| Lamp | 2:22 pm | 10:32 am | | off | off | | | | | | |
| | | Aug. 29, 2007- | Magenta | 0% | 0% | 66.7% | 81.5% | 256.8% | 69.1% | 84.0% | >250% |
| | | 10:38 am | | off | off | | | | | | |
| | | Aug. 29, 2007- | Yellow | 0% | 0% | 55.6% | 74.1% | 204.9% | 61.7% | 91.4% | 185.2% |
| | | 10:45 am | | off | off | | | | | | |
| | | Aug. 29, 2007- | Black | 0% | 0% | 43.2% | 59.3% | 235.8% | 43.2% | 58.0% | 237.0% |
| | | 10:51 am | | off | off | | | | | | |

After one week, all the samples were passed tape test. For the extension test, the both lamp samples were easier to crack than other samples. All samples' break points were not detectable. The extension test for leading lamp samples and trailing lamp samples were very close. Compared with two days samples, the one week both lamp samples were more flexible and less cracking.

Material: 3M 220W Time Duration: Two Weeks

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 21, 2007- | Sep. 4, 2007- | Cyan | 0% | 0% | 44.4% | 49.4% | 54.3% | 50.6% | 60.5% | 69.1% |
| Lamp | 1:50 pm | 8:45 am | | off | off | | | | | | |
| | | Sep. 4, 2007- | Magenta | 0% | 0% | 61.7% | 70.4% | 125.9% | 65.4% | 76.5% | 113.6% |
| | | 8:53 am | | off | off | | | | | | |
| | | Sep. 4, 2007- | Yellow | 0% | 0% | 35.8% | 40.7% | 40.7% | 35.8% | 37.0% | 42.0% |
| | | 9:00 am | | off | off | | | | | | |
| | | Sep. 4, 2007- | Black | 0% | 0% | 46.9% | 59.3% | 75.3% | 42.0% | 53.1% | 67.9% |
| | | 9:05 am | | off | off | | | | | | |
| Trailing | Aug. 21, 2007- | Sep. 4, 2007- | Cyan | 0% | 0% | 29.6% | 43.2% | 51.9% | 24.7% | 33.3% | 44.4% |
| Lamp | 2:25 pm | 9:15 am | | off | off | | | | | | |
| | | Sep. 4, 2007- | Magenta | 0% | 0% | 56.8% | 69.1% | 82.7% | 64.2% | 71.6% | 95.1% |
| | | 9:20 am | | off | off | | | | | | |
| | | Sep. 4, 2007- | Yellow | 0% | 0% | 35.8% | 50.6% | 50.6% | 37.0% | 51.9% | 56.8% |
| | | 9:26 am | | off | off | | | | | | |
| | | Sep. 4, 2007- | Black | 0% | 0% | 35.8% | 49.4% | 61.7% | 37.0% | 40.7% | 40.7% |
| | | 9:35 am | | off | off | | | | | | |
| Both | Aug. 21, 2007- | Sep. 4, 2007- | Cyan | 0% | 0% | 17.3% | 18.5% | 18.5% | 13.6% | 13.6% | 13.6% |
| Lamp | 3:15 pm | 9:42 am | | off | off | | | | | | |
| | | Sep. 4, 2007- | Magenta | 0% | 0% | 25.9% | 34.6% | 34.6% | 27.2% | 32.1% | 39.5% |
| | | 9:45 am | | off | off | | | | | | |
| | | Sep. 4, 2007- | Yellow | 0% | 0% | 13.6% | 13.6% | 13.6% | 19.8% | 22.2% | 22.2% |
| | | 9:48 am | | off | off | | | | | | |
| | | Sep. 4, 2007- | Black | 0% | 0% | 21.0% | 21.0% | 21.0% | 17.3% | 22.2% | 22.2% |
| | | 9:52 am | | off | off | | | | | | |

After two weeks, all the samples were passed tape test. For the extension test, still both lamp samples were easier to crack and less flexible compared with other samples. Compared with one week samples, leading lamp samples had more flexibility. For trailing lamp and both lamp samples, the percentage of cracking point and flexibility has been decreased.

Material: IJ180CV2 Time Duration: Two Weeks

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 22, 2007- | Sep. 5, 2007- | Cyan | 0% | 0% | 54.3% | 63.0% | 70.4% | 50.6% | 61.7% | 70.4% |
| Lamp | 11:10 am | 11:00 am | | off | off | | | | | | |
| | | Sep. 5, 2007- | Magenta | 0% | 0% | 80.2% | 92.6% | 154.3% | 74.1% | 81.5% | 107.4% |
| | | 11:07 am | | off | off | | | | | | |
| | | Sep. 5, 2007- | Yellow | 0% | 0% | 37.0% | 46.9% | 50.6% | 40.7% | 42.0% | 42.0% |
| | | 11:15 am | | off | off | | | | | | |
| | | Sep. 5, 2007- | Black | 0% | 0% | 50.6% | 59.3% | 92.6% | 43.2% | 58.0% | 85.2% |
| | | 11:22 am | | off | off | | | | | | |
| Trailing | Aug. 22, 2007- | Sep. 5, 2007- | Cyan | 0% | 0% | 60.5% | 66.7% | 67.9% | 60.5% | 67.9% | 67.9% |
| Lamp | 10:50 am | 1:58 pm | | off | off | | | | | | |
| | | Sep. 5, 2007- | Magenta | 0% | 0% | 71.6% | 79.0% | 91.4% | 69.1% | 76.5% | 86.4% |
| | | 2:07 pm | | off | off | | | | | | |
| | | Sep. 5, 2007- | Yellow | 0% | 0% | 53.1% | 59.3% | 59.3% | 53.1% | 61.7% | 64.2% |
| | | 2:13 pm | | off | off | | | | | | |
| | | Sep. 5, 2007- | Black | 0% | 0% | 56.8% | 63.0% | 69.1% | 55.6% | 66.7% | 79.0% |
| | | 2:20 pm | | off | off | | | | | | |
| Both | Aug. 22, 2007- | Sep. 5, 2007- | Cyan | 0% | 0% | 25.9% | 27.2% | 27.2% | 22.2% | 29.6% | 29.6% |
| Lamp | 10:00 am | 2:30 pm | | off | off | | | | | | |
| | | Sep. 5, 2007- | Magenta | 0% | 0% | 39.5% | 46.9% | 48.1% | 44.4% | 51.9% | 51.9% |
| | | 2:37 pm | | off | off | | | | | | |
| | | Sep. 5, 2007- | Yellow | 0% | 0% | 21.0% | 24.7% | 25.9% | 19.8% | 19.8% | 19.8% |
| | | 2:43 pm | | off | off | | | | | | |
| | | Sep. 5, 2007- | Black | 0% | 0% | 39.5% | 48.1% | 51.9% | 35.8% | 43.2% | 45.7% |
| | | 2:48 pm | | off | off | | | | | | |

After two weeks, all the samples were passed tape test. For the extension test, both lamp samples were less flexible and easier to crack. Compared with one week samples, both lamp and leading lamp samples were close, little more flexible. For Trailing lamp samples, the extension is less flexible than one week samples.

Material: IP2517 cast Time Duration: Two Weeks

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 23, 2007- | Sep. 6, 2007- | Cyan | 0% | 0% | 76.5% | 97.5% | Not | 71.6% | 87.7% | Not |
| Lamp | 11:00 am | 9:20 am | | off | off | | | Detectable | | | Detectable |
| | | Sep. 6, 2007- | Magenta | 0% | 0% | 133.3% | 146.9% | 244.4% | 112.3% | 149.4% | Not |
| | | 9:28 am | | off | off | | | | | | Detectable |
| | | Sep. 6, 2007- | Yellow | 0% | 0% | 113.6% | 137.0% | Not | 122.2% | 148.1% | Not |
| | | 9:37 am | | off | off | | | Detectable | | | Detectable |
| | | Sep. 6, 2007- | Black | 0% | 0% | 93.8% | 103.7% | Not | 77.8% | 97.5% | Not |
| | | 9:45 am | | off | off | | | Detectable | | | Detectable |
| Trailing | Aug. 23, 2007- | Sep. 6, 2007- | Cyan | 0% | 0% | 79.0% | 95.1% | 239.5% | 91.4% | 104.9% | 238.3% |
| Lamp | 10:50 am | 9:52 am | | off | off | | | | | | |
| | | Sep. 6, 2007- | Magenta | 0% | 0% | 92.6% | 109.9% | 245.7% | 95.1% | 117.3% | Not |
| | | 10:01 am | | off | off | | | | | | Detectable |
| | | Sep. 6, 2007- | Yellow | 0% | 0% | 88.9% | 123.5% | 248.1% | 91.4% | 121.0% | 249.4% |
| | | 10:09 am | | off | off | | | | | | |
| | | Sep. 6, 2007- | Black | 0% | 0% | 90.1% | 102.5% | 254.3% | 84.0% | 93.8% | 245.7% |
| | | 10:17 am | | off | off | | | | | | |
| Both | Aug. 22, 2007- | Sep. 5, 2007- | Cyan | 0% | 0% | 50.6% | 64.2% | 158.0% | 59.3% | 70.4% | 154.3% |
| Lamp | 2:22 pm | 2:55 pm | | off | off | | | | | | |
| | | Sep. 5, 2007- | Magenta | 0% | 0% | 75.3% | 92.6% | 244.4% | 74.1% | 96.3% | Not |
| | | 3:00 pm | | off | off | | | | | | Detectable |
| | | Sep. 5, 2007- | Yellow | 0% | 0% | 58.0% | 72.8% | 166.7% | 70.4% | 86.4% | 167.9% |
| | | 3:10 pm | | off | off | | | | | | |
| | | Sep. 5, 2007- | Black | 0% | 0% | 51.9% | 63.0% | 235.8% | 55.6% | 69.1% | 198.8% |
| | | 3:16 pm | | off | off | | | | | | |

After two weeks, all the samples were passed tape test. For the extension test, still both lamp samples were easier to crack and less flexible compared with other samples. Compared with one hour and one day samples, the two days samples were little easier to crack and less flexible.

Material: 3M 220W Time Duration: Three Weeks

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 21, 2007- | Sep. 11, 2007- | Cyan | 0% | 0% | 40.7% | 46.9% | 46.9% | 45.7% | 49.4% | 54.3% |
| Lamp | 1:50 pm | 4:15 pm | | off | off | | | | | | |
| | | | Magenta | 0% | 0% | 64.2% | 74.1% | 106.2% | 71.6% | 81.5% | 123.5% |
| | | | | off | off | | | | | | |
| | | | Yellow | 0% | 0% | 25.9% | 25.9% | 25.9% | 34.6% | 34.6% | 34.6% |
| | | | | off | off | | | | | | |
| | | | Black | 0% | 0% | 42.0% | 53.1% | 64.2% | 43.2% | 55.6% | 72.8% |
| | | | | off | off | | | | | | |
| Trailing | Aug. 21, 2007- | Sep. 11, 2007- | Cyan | 0% | 0% | 35.8% | 44.4% | 44.4% | 37.0% | 43.2% | 43.2% |
| Lamp | 2:25 pm | 4:30 pm | | off | off | | | | | | |
| | | | Magenta | 0% | 0% | 60.5% | 69.1% | 88.9% | 56.8% | 69.1% | 77.8% |
| | | | | off | off | | | | | | |
| | | | Yellow | 0% | 0% | 37.0% | 39.5% | 39.5% | 37.0% | 45.7% | 45.7% |
| | | | | off | off | | | | | | |
| | | | Black | 0% | 0% | 49.4% | 58.0% | 67.9% | 43.2% | 49.4% | 56.8% |
| | | | | off | off | | | | | | |
| Both | Aug. 21, 2007- | Sep. 11, 2007- | Cyan | 0% | 0% | 14.8% | 14.8% | 14.8% | 18.5% | 19.8% | 19.8% |
| Lamp | 3:15 pm | 4:47 pm | | off | off | | | | | | |
| | | | Magenta | 0% | 0% | 24.7% | 24.7% | 24.7% | 27.2% | 30.9% | 30.9% |
| | | | | off | off | | | | | | |
| | | | Yellow | 0% | 0% | 18.5% | 18.5% | 18.5% | 14.8% | 14.8% | 14.8% |
| | | | | off | off | | | | | | |
| | | | Black | 0% | 0% | 17.3% | 21.0% | 21.0% | 16.0% | 21.0% | 21.0% |
| | | | | off | off | | | | | | |

After three weeks, all the samples were passed tape test. For the extension test, still both lamp samples were easier to crack and less flexible compared with other samples. The test results for three weeks samples were very close to two weeks samples.

Material: IJ180CV2 Time Duration: Three Weeks

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 22, 2007- | Sep. 12, 2007- | Cyan | 0% | 0% | 50.6% | 63.0% | 75.3% | 54.3% | 63.0% | 75.3% |
| Lamp | 11:10 am | 11:34 am | | off | off | | | | | | |
| | | | Magenta | 0% | 0% | 74.1% | 82.7% | 130.9% | 65.4% | 76.5% | 111.1% |
| | | | | off | off | | | | | | |
| | | | Yellow | 0% | 0% | 45.7% | 53.1% | 58.0% | 50.6% | 58.0% | 60.5% |
| | | | | off | off | | | | | | |
| | | | Black | 0% | 0% | 53.1% | 59.3% | 84.0% | 46.9% | 56.8% | 79.0% |
| | | | | off | off | | | | | | |
| Trailing | Aug. 22, 2007- | Sep. 12, 2007- | Cyan | 0% | 0% | 44.4% | 50.6% | 50.6% | 56.8% | 61.7% | 65.4% |
| Lamp | 10:50 am | 3:35 pm | | off | off | | | | | | |
| | | | Magenta | 0% | 0% | 67.9% | 75.3% | 90.1% | 74.1% | 80.2% | 85.2% |
| | | | | off | off | | | | | | |
| | | | Yellow | 0% | 0% | 48.1% | 59.3% | 63.0% | 55.6% | 64.2% | 69.1% |
| | | | | off | off | | | | | | |
| | | | Black | 0% | 0% | 55.6% | 64.2% | 74.1% | 53.1% | 61.7% | 67.9% |
| | | | | off | off | | | | | | |
| Both | Aug. 22, 2007- | Sep. 12, 2007- | Cyan | 0% | 0% | 16.0% | 16.0% | 16.0% | 22.2% | 24.7% | 24.7% |
| Lamp | 10:00 am | 4:00 pm | | off | off | | | | | | |
| | | | Magenta | 0% | 0% | 39.5% | 45.7% | 45.7% | 44.4% | 44.4% | 44.4% |
| | | | | off | off | | | | | | |
| | | | Yellow | 0% | 0% | 25.9% | 25.9% | 25.9% | 24.7% | 24.7% | 24.7% |
| | | | | off | off | | | | | | |
| | | | Black | 0% | 0% | 29.6% | 39.5% | 43.2% | 28.4% | 38.3% | 38.3% |
| | | | | off | off | | | | | | |

After three weeks, all the samples were passed tape test. For the extension test, still both lamp samples were easier to crack and less flexible compared with other samples. The three weeks samples were very close to two weeks samples, no dramatically changing.

Material: 250W Time Duration: Three Weeks

| Print | Print | Test | Colors | | | Initial | Major | | Initial | Major | |
|---|---|---|---|---|---|---|---|---|---|---|---|
| Mode | Date/Time | Date/Time | (#6061) | 1 | 2 | Crack | Crack | Break | Crack | Crack | Break |
| Leading | Aug. 23, 2007- | Sep. 12, 2007- | Cyan | 0% | 0% | 90.1% | 108.6% | 213.6% | 86.4% | 101.2% | >250% |
| Lamp | 11:00 am | 4:20 pm | | off | off | | | | | | |
| | | | Magenta | 0% | 0% | 143.2% | 153.1% | >250% | 107.4% | 143.2% | >250% |
| | | | | off | off | | | | | | |
| | | | Yellow | 0% | 0% | 92.6% | 119.8% | >250% | 124.7% | 146.9% | >250% |
| | | | | off | off | | | | | | |
| | | | Black | 0% | 0% | 93.8% | 106.2% | >250% | 102.5% | 121.0% | >250% |
| | | | | off | off | | | | | | |
| Trailing | Aug. 23, 2007- | Sep. 13, 2007- | Cyan | 0% | 0% | 86.4% | 102.5% | 223.5% | 80.2% | 96.3% | 213.6% |
| Lamp | 10:50 am | 11:00 am | | off | off | | | | | | |
| | | | Magenta | 0% | 0% | 92.6% | 111.1% | >250% | 98.8% | 104.9% | >250% |
| | | | | off | off | | | | | | |
| | | | Yellow | 0% | 0% | 98.8% | 103.7% | 213.6% | 90.1% | 101.2% | >250% |
| | | | | off | off | | | | | | |
| | | | Black | 0% | 0% | 82.7% | 96.3% | 234.6% | 74.1% | 95.1% | >250% |
| | | | | off | off | | | | | | |
| Both | Aug. 22, 2007- | Sep. 13, 2007- | Cyan | 0% | 0% | 58.0% | 66.7% | 142.0% | 53.1% | 65.4% | 149.4% |
| Lamp | 2:22 pm | 11:35 am | | off | off | | | | | | |
| | | | Magenta | 0% | 0% | 72.8% | 86.4% | >250% | 67.9% | 84.0% | >250% |
| | | | | off | off | | | | | | |
| | | | Yellow | 0% | 0% | 55.6% | 77.8% | 163.0% | 66.7% | 74.1% | 169.1% |
| | | | | off | off | | | | | | |
| | | | Black | 0% | 0% | 48.1% | 58.0% | >250% | 58.0% | 66.7% | >250% |
| | | | | off | off | | | | | | |

The IP2517 was very flexible. The break point was over 250%. Both lamp samples were less flexible compared with leading lamp and both lamp. Three weeks samples were very close to two weeks samples, no dramatic changes.

Although the invention has been described in conjunction with specific embodiments, many alternatives and variations can be apparent to those skilled in the art in light of this description and the annexed drawings. Accordingly, the invention is intended to embrace all of the alternatives and variations that fall within the spirit and the scope of the appended claims.

What is claimed is:

1. A method for providing improved flexibility of ink printed on a substrate, comprising:
controlling cure of an ink composition.

2. A method as claimed in claim 1, wherein the ink is a U.V. ink composition.

3. A method as claimed in claim 2, wherein the cure controlling further includes:
controlling irradiation of the U.V. ink composition.

4. A method as claimed in claim 1 wherein the ink is a cationic ink composition.

5. A method as claimed in claim 1, wherein the cure controlling of the ink composition further includes controlling flexibility of the substrate being applied with the ink.

6. A method as claimed in claim 5, wherein the ink is a U.V. ink composition.

7. A method as claimed in claim 6, wherein the cure controlling further includes controlling irradiation of a U.V. ink composition.

8. A method as claimed in claim 5, wherein the ink is a cationic ink composition.

9. A method as claimed in claim 1 further includes, applying the ink in a relatively thick layer.

10. A method as claimed in claim 1, wherein the relatively thick layer of ink is at about 42 pl ink drops on a 360×360 drop per inch grid.

11. An apparatus for providing improved flexibility of ink printed on a substrate, comprising:
means for controlling cure of ink.

12. An apparatus as claimed in claim 11, wherein the controlling means controls the flexibility of the substrate being applied with the ink.

13. An apparatus for providing flexibility of an ink printed on a substrate or the substitute being applied with the ink, comprising:
at least one light source arranged across a substrate opposite a print moving direction.

14. An apparatus as claimed in claim 13, wherein the light source is a U.V. light source.

15. An apparatus as claimed in claim 14, wherein the U.V. light source has a 254 nm light bulb.
